(19) United States
(12) Patent Application Publication
(10) Pub. No.: US 2025/0199285 A1
(43) Pub. Date: Jun. 19, 2025

(54) HIGH-SPEED OPTICAL PHASE MEASUREMENT SYSTEM, MEASUREMENT METHOD AND APPLICATION THEREOF

(71) Applicant: Wuhan Hantuo Technology Co., Ltd., Hubei (CN)

(72) Inventors: Jinlong Zhu, Hubei (CN); Zedi Li, Hubei (CN)

(73) Assignee: Wuhan Hantuo Technology Co., Ltd., Hubei (CN)

(21) Appl. No.: 18/757,371

(22) Filed: Jun. 27, 2024

(30) Foreign Application Priority Data
Dec. 14, 2023 (CN) 202311726067.9

(51) Int. Cl. G02B 21/14; G02B 21/36

(52) U.S. Cl. CPC G02B 21/14; G02B 21/361

(57) ABSTRACT

Disclosed are a high-speed optical phase measurement system, a measurement method and an application thereof. The system includes an illumination module, a microscope module, an interference module, a camera module, a high-precision positioning stage and a control and data processing module. The illumination module, microscope module and interference module form an interferometer, with a preset angle between the reference mirror and the plane perpendicular to the optical axis; the high-precision positioning stage is configured to carry the sample and provide stable and accurate scanning; the emitted light from the collimated light source passes through the objective lenses and is incident on the sample and reference mirror respectively, the reflected light of the sample interferes with the reference light and is collected by the camera module; the control and data processing module implements on-line phase measurement based on the interference image.

### CROSS-REFERENCE TO RELATED APPLICATION

This application claims the priority benefit of China application serial no. 202311726067.9, filed on Dec. 14, 2023. The entirety of the above-mentioned patent application is hereby incorporated by reference herein and made a part of this specification.

### BACKGROUND

### Technical Field

The present disclosure belongs to the technical field related to phase measurement, and more specifically, relates to a high-speed optical phase measurement system, a measurement method and an application thereof.

### Description of Related Art

Phase, as one of the information carried by light, changes periodically over time. After light passes through a sample or is reflected by a sample surface, different space-time lags are generated at different positions, and therefore the phase is able to characterize the sample. Phase measurement has incomparable advantages, such as extremely high longitudinal resolution and sensitivity, contact-free and label-free, and sensitivity to anisotropic materials. Nowadays, phase measurements are commonly adopted in various fields. In histology and cytology, phase measurement may achieve high-contrast quantitative measurements using an optical path difference of tissues or cell structures; in optics, phase measurement may be adopted to correct laser waveforms or characterize certain parameters and characteristics of optical systems; in the field of micro-nano manufacturing, phase measurement may be adopted for measurement of nanometer three-dimensional structure, film thickness or refractive index detection, micro-nano structure optical property analysis, etc.

Currently, the most well-developed phase measurement method is interferometry, among which phase-shifting interference microscopy is one of the most important methods. Since P. Carré proposed the basic concept of temporal phase-shifting interferometry in 1966, phase-shifting interference microscopy has undergone rapid development over more than half a century. Compared with analytical static interferograms, phase-shifting interference microscopy has higher spatial resolution and accuracy, and is adaptable to low-contrast and arbitrary carrier frequency interference fringes. Therefore, phase-shifting interference microscopy has broad applicability to various interferometers, such as Green interferometer, Fizeau interferometer, Mach-Zehnder interferometer and transverse shear interferometer, etc. Although phase-shifting interferometry has many advantages, such as high precision, non-contact, and high utilization of spatial bandwidth products, there are also some limitations, for example, the requirement for multi-focal plane data collection, the requirement for complex phase unwrapping processes, the signal collection process being easily affected by noise, and the requirement for tiling for large field-of-view measurements. The above problems dramatically affect the quality of 3D topography reconstruction.

In view of the above, there is an urgent need for an ultra-large field-of-view micro-nano measurement method in the following fields, such as high-speed wafer inspection, photolithography exposure non-uniformity and defect detection, characterization of large-area biological materials, high-speed photovoltaic thin film inspection, component surface quality and flatness inspection, optical waveguide and optical fiber analysis, so as to achieve high-speed, high-precision, and large-area measurement and analysis.

### SUMMARY

In view of the above defects or needs for improvement of the existing technology, the present disclosure provides a high-speed optical phase measurement system, a measurement method and an application thereof, which may realize an infinite field-of-view fast phase measurement in one direction.

In order to achieve the above purpose, an aspect of the present disclosure provides a high-speed optical phase measurement system, including an illumination module, a microscope module, an interference module, a camera module, a high-precision positioning stage, and a control and data processing module. The illumination module includes a collimated light source; the microscope module includes a beam splitter; and the interference module includes an objective lens and a reference mirror, wherein a preset angle is set between the reference mirror and a plane perpendicular to an optical axis, and the preset angle is not 0°; the high-precision positioning stage is configured to carry a sample, and a moving assembly is disposed under the high-precision positioning stage, thereby driving the sample to move; the distance between the sample and the objective lens is equal to the distance between the objective lens and the reference mirror, and the reference mirror and the sample are both conjugate with a plane of the camera module; an emitted light from the collimated light source enters the objective lens and the reference mirror after passing through the beam splitter, the emitted light is incident on a sample surface after passing through the objective lens, the reflected light reflected by the sample interferes with the reference light reflected by the reference mirror and is collected by the camera module; the control and data processing module implements phase measurement based on interference images collected by the camera module.

Preferably, the relationship between the moving scanning speed of the high-precision positioning stage and the number of frames of the camera module is:

$$\frac{v}{fps} \times M = Pxsize$$

In the equation, v is a moving scanning speed of the high-precision positioning stage, fps is a frame rate of the camera, M is a system magnification, and Pxsize is a camera pixel size.

Preferably, the objective lens includes a first objective lens and a second objective lens of the same model. The reference mirror is disposed at the focus of the first objective lens, the sample is disposed at the focus of the second objective lens, and the collimated light source is incident on the first objective lens and the second objective lens respectively after being split by the beam splitter.

Preferably, the reference mirror is disposed between the beam splitter and the half-mirror in the objective lens, and the distance between the reference mirror and the half-mirror is the same as the distance between the half-mirror and the sample.

Preferably, the beam splitter is disposed between the objective lens and the sample, the reference mirror is disposed on the reflection optical path of the beam splitter, and the distance between the reference mirror and the beam splitter is equal to the distance between the sample and the beam splitter.

Preferably, the inclination angle of the beam splitter is 45°, and the preset angle α between the reference mirror and the plane perpendicular to the optical axis is obtained using the following equation:

$$α = arc tan [ \frac{{f}_{2}}{{f}_{1}} tan {α}^{′} ] \\ {α}^{′} = arc tan ( \frac{\frac{2 π}{3} \times \frac{λ}{2 π}}{d} )$$

In the equation, f₁ is the focal length of the objective lens, f₂ is the focal length of the tube lens, λ is the central wavelength of the light source, and d is the distance between two columns of pixels.

A second aspect of the disclosure provides a phase measurement method based on the above-mentioned high-speed optical phase measurement system, including: S1: using multiple columns of pixels on the camera module as collection points, wherein multiple columns of pixels are distributed at equal intervals, and each column of pixels is parallel to the interference fringe; S2: activating the high-precision positioning stage for scanning, wherein when the interference fringe appears on the first column of pixels, the image signal is collected and stored in the first buffer area to form the first image sequence, when the interference fringe appears on the second column of pixels, the image signal is collected and stored in the second buffer area to form the second image sequence, in this way, the first image sequence, the second image sequence, . . . , and the N-th image sequence are obtained; S3: processing the image at the starting point in the first image sequence, the second image sequence, . . . , and the N-th image sequence using the phase-shifting algorithm to obtain the phase of the sample to be measured.

Preferably, the phase-shifting algorithm in step S3 is specifically:

$$ϕ ( x , y ) = {tan}^{- 1} \frac{{\sum }_{n = 0}^{N - 1} {I}_{n} ( x , y ) sin ( 2 π n / N )}{{\sum }_{n = 0}^{N - 1} {I}_{n} ( x , y ) cos ( 2 π n / N )}$$

In the equation, ϕ(x,y) is the phase to be measured, and Iₙ(x,y) is the image at the starting point in the N-th image sequence.

A third aspect of the present disclosure provides an application of the phase measurement method to obtain the depth of the sample based on the phase to be measured, and thereby obtaining the three-dimensional morphology of the sample.

Preferably, the depth h(x,y) of the sample is obtained according to the following equation:

$$h ( x , y ) = \frac{λ}{2 π} \cdot ϕ ( x , y )$$

In the equation, λ is a wavelength of the sample.

Generally speaking, compared with the existing technology through the above technical solutions conceived by the present disclosure, the high-speed optical phase measurement system, measurement method and application thereof provided by the present disclosure mainly have the following advantageous effects:

1. Compared with conventional phase-shifting interferometers, which generates phase shifts using step vertical scanning of the objective lens to obtain interferograms, the present disclosure has a preset angle between the reference mirror and the plane perpendicular to the optical axis, that is, the present disclosure generates phase shifts using inclination of the reference mirror without having to perform vertical objective lens scanning. The structure of the present disclosure is simple, stable and economical.

2. Different from the conventional large field-of-view phase measurement method, which requires multiple shutdowns for measurement and image tiling coupling, the present disclosure performs scanning through a high-precision positioning stage using a principle similar to that of a document scanner. By performing integral imaging in conjunction with a line scan camera, the collection may proceed continuously as long as the high-precision positioning stage keeps moving, and the size of the field of view is determined by the stroke of the high-precision positioning stage. An ultra-large field-of-view imaging may be achieved in one time without the need for image tiling.

3. Compared with digital holographic microscopy, the phase solution process involves Fourier transform and low-pass filtering. The method of the present disclosure is performed by extracting the pixels at the same position in each image after collecting multiple images, and performing phase recovery after substituting the phase-shifting algorithm. In this way, the method of the present disclosure does not involve the process of low-pass filtering, and may fully utilize the spatial bandwidth product of the microscopy system.

4. Compared with conventional transverse scanning white light interference, which generates phase shifts through the inclination of the entire imaging system, the method of the present disclosure generates phase shifts through the inclination of reference mirror, and the objective lens does not incline, so the imaging will not be out of focus. Moreover, the present disclosure adopts linear pixel scanning, which is faster and suitable for online measurement.

### BRIEF DESCRIPTION OF THE DRAWINGS

FIG. 1 is a schematic structural view of a high-speed optical phase measurement system according to an embodiment of the present disclosure.

FIG. 2A is a first type of interference module according to an embodiment of the present disclosure.

FIG. 2B is a second type of interference module according to an embodiment of the present disclosure.

FIG. 2C is a third type of interference module according to an embodiment of the present disclosure.

FIG. 3 is an original interferogram collected by a camera according to an embodiment of the present disclosure.

FIG. 4 is a schematic view of a scanning method of a high-precision positioning stage according to an embodiment of the present disclosure.

FIG. 5A is a schematic view of an area scan camera according to an embodiment of the present disclosure.

FIG. 5B is a schematic view of a line scan camera according to an embodiment of the present disclosure.

FIG. 6A is a first phase shift interferogram according to an embodiment of the present disclosure.

FIG. 6B is a second phase shift interferogram according to an embodiment of the present disclosure.

FIG. 6C is a third phase shift interferogram according to an embodiment of the present disclosure.

FIG. 6D is a fourth phase shift interferogram according to an embodiment of the present disclosure.

FIG. 7A is a three-dimensional view of a three-dimensional structure of a micro-nano circular boss sample tested in an embodiment of the present disclosure.

FIG. 7B is a two-dimensional view of the three-dimensional structure of the micro-nano circular boss sample tested in an embodiment of the present disclosure.

FIG. 8 is an explanatory diagram of an inclination angle of a reference mirror in an embodiment of the present disclosure.

### DESCRIPTION OF THE EMBODIMENTS

In order to make the purpose, technical solutions and advantages of the present disclosure more clear, the present disclosure will be further described in detail below with reference to the accompanying drawings and embodiments. It should be understood that the specific embodiments described here are only used to explain the present disclosure and are not intended to limit the present disclosure. In addition, the technical features involved in the various embodiments of the present disclosure described below can be combined with each other as long as they do not conflict with each other.

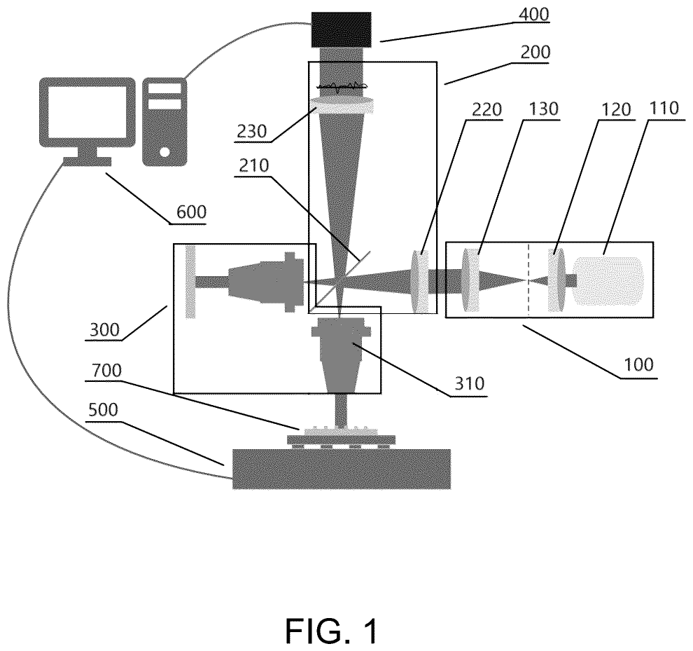

The first aspect of the present disclosure provides a high-speed optical phase measurement system. As shown in FIG. 1, the system includes an illumination module 100, a microscope module 200, an interference module 300, a camera module 400, a high-precision positioning stage 500 and a control and data processing module 600.

The illumination module 100 includes a collimated light source 110.

The microscope module 200 includes a beam splitter 210.

The interference module 300 includes an objective lens 310 and a reference mirror 320, wherein a preset angle is set between the reference mirror 320 and the plane perpendicular to the optical axis, and the preset angle is not 0°.

The high-precision positioning stage 500 is configured to carry the sample. There is a moving assembly disposed under the high-precision positioning stage 500, thereby driving the sample to move.

The distance between the sample and the objective lens 310 is equal to the distance between the objective lens 310 and the reference mirror 320.

The emitted light from the collimated light source 110 is incident on the objective lens 310 and the reference mirror 320 after passing through the beam splitter 210. The emitted light is incident on the sample surface after passing through the objective lens 310. The reflected light reflected by the sample interferes with the reference light reflected by the reference mirror 320 and is collected by the camera module 400.

The control and data processing module 600 implements phase measurement based on the interference image collected by the camera module 400.

In a further preferred solution, the illumination module 100 further includes a converging lens 120 and a collection lens 130 disposed on the optical path of the collimated light source 110. The collimated light source 110 may be selected from laser or quasi-monochromatic light. The light beam is collimated and expanded after passing through the lens group to meet the requirements of uniform illumination covering the entire imaging area, and then the light beam is guided into the microscope module 200.

In a further preferred solution, the microscope module 200 further includes a light collecting lens 220 and a tube lens 230. The light beam of the collection lens 130 is input to the light collecting lens 220. The tube lens 230 is disposed between the beam splitter 210 and the camera module 400. The light beam is incident on the objective lens 310 from the light collecting lens 220 via the beam splitter 210 and is finally illuminated on the sample 700.

The sample 700 is placed on the high-precision positioning stage 500, and the sample 700 is imaged onto the imaging plane of the camera module 400 through the microscope module 200. The reference mirror 320 and the sample 700 in the interference module 300 are both conjugate with the plane of the camera module 400, thereby generating interference fringes under low-coherence illumination.

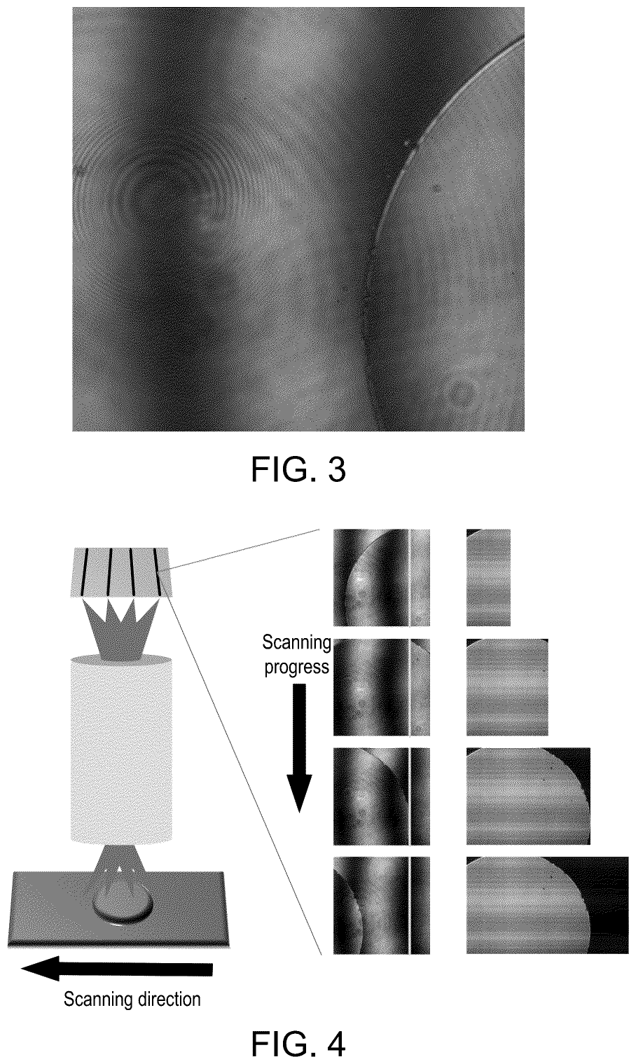

There is a preset angle between the reference mirror 320 in the interference module 300 and the plane perpendicular to the optical axis. The preset angle is not 0°. The preset angle is preferably a, that is, the reference mirror 320 is slightly inclined with respect to the plane perpendicular to the optical axis. As shown in FIG. 3, light carrier frequency interference fringes are formed on the camera module 400. The inclination method may be implemented using a variety of technologies, such as adjustment screws, pitch shift stages, wedge-shaped spacers, etc. The density of interference fringes may be adjusted by adjusting the inclination angle of the reference mirror, and the direction of the interference fringes may be adjusted by adjusting the inclination direction of the reference mirror.

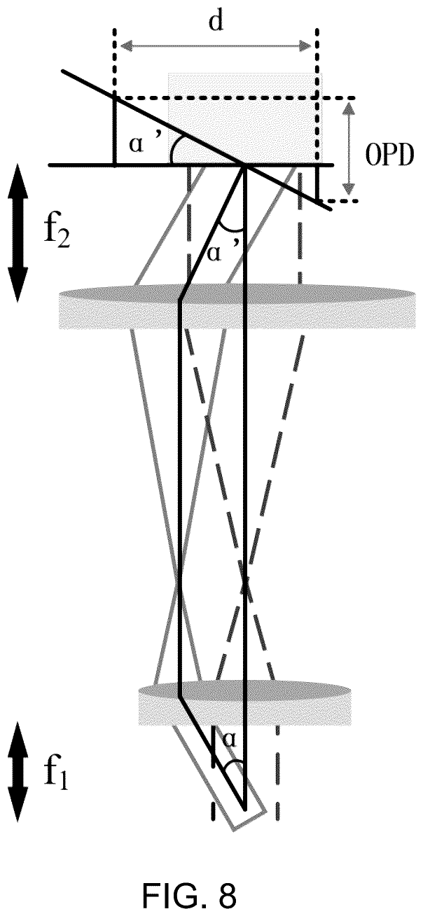

The inclination angle α of the reference mirror 320 in the interference module 300 varies depending on many factors, including the magnification of the microscope module 200, the number and spacing of column pixels selected for the camera module 400, etc. As shown in FIG. 8, α is the inclination angle of the reference mirror. After passing through the microscope module, the reflected light is illuminated on the surface of the camera module at an angle α′. The relationship between α and α′ is determined by the magnification of the microscope module 200, and the relationship is:

$${α}^{′} = arctan [ \frac{{f}_{1}}{{f}_{2}} tan α ]$$

In the equation, f₁ and f₂ are the focal lengths of the objective lens 310 and the tube lens 230 respectively. The interval between column pixels is d, and the optical path difference between two column vectors is OPD. The four-step phase shift algorithm preferably used in this example generally makes the OPD at 2π/3. Under this premise, the limitation requirement for the presence of α′ is:

$${α}^{′} = arctan ( \frac{\frac{2 π}{3} \times \frac{λ}{2 π}}{d} )$$

Here, λ is the central wavelength of the system illumination. The optimal α value may be calculated by combining two equations.

The collimated beam generated by the illumination module 100 is vertically illuminated on the reference mirror 320 after passing through the microscope module 200. Due to the slight inclination of the reference mirror 320, the reflected reference light is also slightly inclined. However, under the circumstances, the light that also passes through the microscope module 200 and the interference module 300 and is vertically illuminated on the sample 700 is reflected vertically. After being transmitted by the microscope system, the two light beams interfere with each other on the camera module 400. However, under the circumstances, the reflected reference light is inclined with respect to the optical axis, and the reflected sample light is horizontally perpendicular to the optical axis. Therefore, interference fringes are formed on the camera module 400.

In a further preferred solution, the relationship between the moving scanning speed of the high-precision positioning stage 500 and the number of frames of the camera module 400 is:

$$\frac{v}{fps} \times M = Pxsize$$

In the equation, v is a moving scanning speed of the high-precision positioning stage 500, fps is a frame rate of the camera, M is a system magnification, and Pxsize is a camera pixel size.

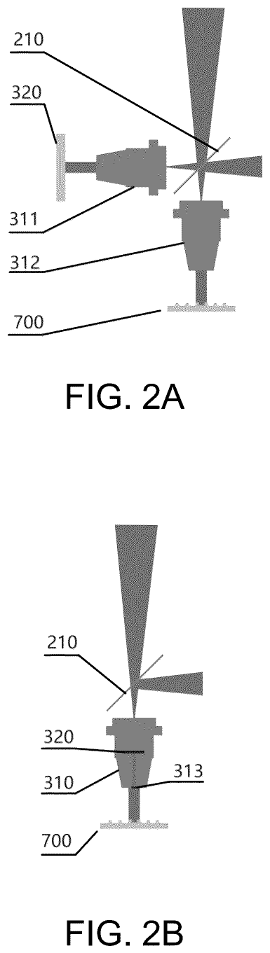

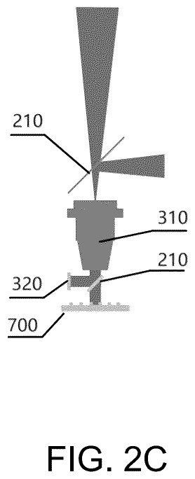

In a further preferred solution, as shown in FIG. 2A, the objective lens 310 includes the first objective lens 311 and the second objective lens 312 of the same model. The reference mirror 320 is disposed at the focus of the first objective lens 311, and the sample is disposed at the focus of the second objective lens 312. The collimated light source 110 is incident on the first objective lens 311 and the second objective lens 312 respectively after being split by the beam splitter 210.

In a further preferred solution, as shown in FIG. 2B, the reference mirror 320 is disposed between the beam splitter 210 and the half-mirror 313 in the objective lens 310, and the distance between the reference mirror 320 and the half-mirror 313 is equal to the distance between the half-mirror 313 and the sample.

In a further preferred solution, as shown in FIG. 2C, the beam splitter 210 is disposed between the objective lens 310 and the sample, the reference mirror 320 is disposed on the reflection optical path of the beam splitter 210, and the distance between the reference mirror 320 and the beam splitter 210 is equal to the distance between the sample and the beam splitter 210.

In a further preferred solution, the inclination angle of the beam splitter 210 is 45°.

The second aspect of the present disclosure provides a phase measurement method for the above-mentioned high-speed optical phase measurement system, including the following steps S1 to S3.

S1: Multiple columns of pixels on the camera module 400 are used as collection points, wherein multiple columns of pixels are distributed at equal intervals, and each column of pixel is parallel to the interference fringe.

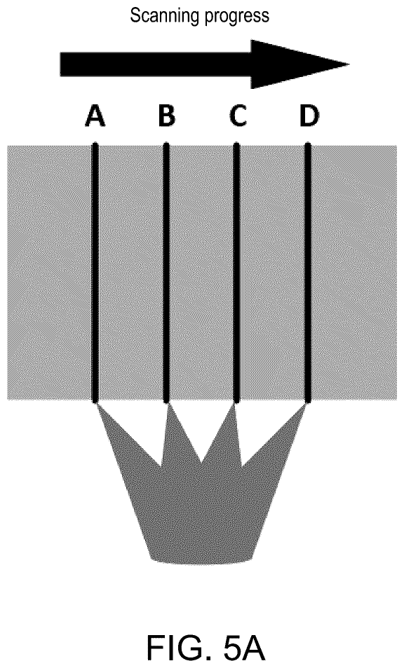

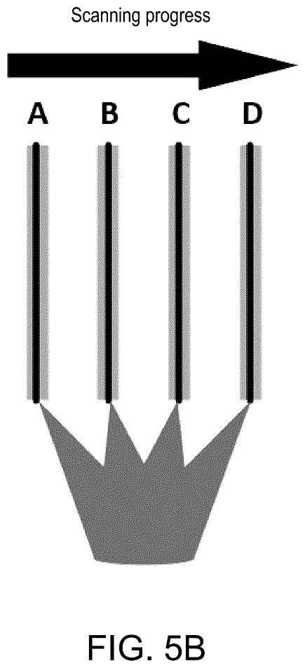

In this embodiment, four columns of pixels are selected as collection points on the camera module 400. As shown in FIG. 4, the interference fringes should be parallel to the four columns of pixels. The four columns of pixels are arranged at equal intervals in a lateral direction, and the spacing between each column of pixels should depend on the selected phase-shifting algorithm. The density of the interference fringes may be changed by adjusting the inclination angle of the reference mirror in the interference module 300 to match the selection of the spacing between each column of pixels. The camera module 400 may be constructed through a variety of methods, such as using an area array high-speed camera, as shown in FIG. 5A, by cropping multiple columns of pixels equidistantly on the high-speed camera plane; or using a line scan camera array or a TDI camera array, as shown in FIG. 5B, by placing multiple line scan camera arrays in parallel at equal intervals, and the placement direction is parallel to the interference fringe direction and perpendicular to the scanning direction.

S2: The high-precision positioning stage 500 is activated for scanning, wherein when the interference fringe appears on the first column of pixels, the image signal is collected and stored in the first buffer area to form the first image sequence, when the interference fringe appears on the second column of pixels, the image signal is collected and stored in the second buffer area to form the second image sequence, in this way, the first image sequence, the second image sequence, . . . , and the N-th image sequence are obtained.

The control and data processing module 600 receives the speed signal of the high-precision positioning stage 500 and the image signal of the camera module 400, sends a periodic signal to control the collection frequency of the camera module 400, and adjusts the speed of the high-precision positioning stage 500. The control and data processing module 600 controls the high-precision positioning stage 500 to move in one direction. Under the circumstances, the camera module 400 starts collecting and transmits the collected images to the control and data processing module 600 in linear array mode.

The control and data processing module 600 controls the high-precision positioning stage 500 to start moving. When the target collection starting point of sample appears in the pixels of column A, the pixels of column A begin to collect image signals and store the image signals in the first buffer area to form the first image sequence. Along with the movement of high-precision positioning stage 500, after a fixed time interval, the target collection starting point of sample appears in the pixels of column B, and the pixels of column B begin to collect image signals and store the image signals in the second buffer area to form the second image sequence. Likewise, after a fixed time interval, the pixels of column C begin to collect image signals and store the image signals in the third buffer area to form the third image sequence. After a fixed time interval, the pixels of column D begin to collect image signals and store the image signals in the fourth buffer area to form the fourth image sequence. When the pixels of column D start to collect image signals, data processing begins.

S3: The image at the starting point in the first image sequence, the second image sequence, . . . , and the N-th image sequence is processed using the phase-shifting algorithm to obtain the phase of the sample to be measured.

The image at the starting point in the first image sequence, the second image sequence, . . . , and the N-th image sequence is extracted respectively, namely, the image at the target collection starting point of the sample, and calculation begins. After calculating the column phase image, the four columns of images in the buffer area are deleted, then the first sequence of the image sequence at this time point is extracted and calculated again. After calculating the column phase image, the sequence thereof is arranged after the previous column phase image, and the cycle continues until the end.

The phase-shifting algorithm used in data processing is a universal phase-shifting algorithm. The so-called phase-shifting algorithm is a method of solving the phase of the object itself by introducing regularly changing phase differences in the interferometer.

In the embodiment, the light transmitted by the sample optical path in FIG. 1 may be expressed as:

E(x,y)=Am(x,y)exp[iϕ(x,y)]

In the equation, E(x,y) is the complex amplitude of the reflected light of the sample, Am(x,y) is the amplitude of the reflected light of the sample, and ϕ(x,y) is the phase of the sample to be measured.

The light transmitted by the reference optical path of the interference module may be expressed as:

Eₙ(x,y)=Aₙ(x,y)exp[iαn]

In the equation, Eₙ(x,y) is the complex amplitude of the reference light with different phase shifts, Aₙ(x,y) is the amplitude of the reference light, and a represents the phase difference between different phase shifts.

On the imaging surface of the camera, two light beams interfere with each other in a superposed manner.

$${I}_{n} ( x , y ) = {\vert E ( x , y ) \vert}^{2} + {\vert {E}_{n} ( x , y ) \vert}^{2} + 2 \vert E ( x , y ) \cdot {E}_{n} ( x , y ) \vert$$

The above equation is generally expressed as:

$${I}_{n} ( x , y ) = A ( x , y ) + B ( x , y ) cos [ ϕ ( x , y ) - α n ]$$

In the equation, x an y are the spatial coordinates of each point on a set of phase-shifted images, Iₙ(x,y) is the n-th interferogram, and A(x,y) is the background light. After multiple phase-shifted images are collected at fixed time intervals, the phase of the sample to be measured may be solved through the phase-shifting algorithm. In the embodiment, an inclined reference mirror is adopted as an alternative to replace the axial scanning of the objective lens to produce a phase shift that changes on the plane perpendicular to the optical axis.

Common phase-shifting algorithms include four-step phase-shifting method, dual three-step phase-shifting method, Hariharan five-step phase-shifting method, etc. Their algorithm expressions are similar to:

$$ϕ ( x , y ) = {tan}^{- 1} \frac{{\sum }_{n = 0}^{N - 1} {I}_{n} ( x , y ) sin ( 2 π n / N )}{{\sum }_{n = 0}^{N - 1} {I}_{n} ( x , y ) cos ( 2 π n / N )}$$

They have a characteristic in common, that is, the requirement of the use of quantitative phase-shifting steps, for example, it is required that the phase shift α between adjacent two interference images to be π/2. Compared with the axial scanning of the objective lens using a sub-nanometer precision piezoelectric displacement stage, the above requirement is more difficult to achieve in this example where the reference mirror inclination is adopted to generate phase shifts. Therefore, the use of the four-step equidistant phase-shifting method is proposed in this example. The phase-shifting algorithm only requires four phase-shifted images with a fixed step size. Such algorithm does not require a quantitative step size, so the selection of pixel spacing is relatively free.

The system requires the following steps to complete a measurement.

Step 1: Focusing is performed on the sample, the scanning area is selected, and the scanning speed and camera frame number are calibrated.

The relationship between the scanning speed and the camera frame number of the high-precision positioning stage is:

$$\frac{v}{fps} \times M = Pxsize$$

In the equation, v is the moving scanning speed of the high-precision positioning stage 500, fps is the frame rate of the camera, M is the system magnification, and Pxsize is the camera pixel size. The purpose is to achieve that the movement of the displacement stage makes the image move exactly by one pixel on the camera, so as to realize complete collection of all sample information without missing or overlapping collections.

Step 2: Scanning is performed, multiple images are collected after scanning, and the phase-shifting algorithm is adopted to perform phase recovery. Taking the four-step equal-step phase-shifting algorithm as an example, the specific steps are:

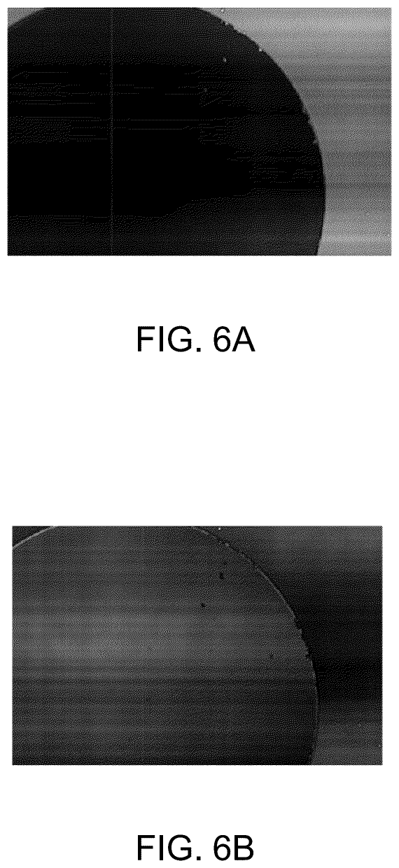

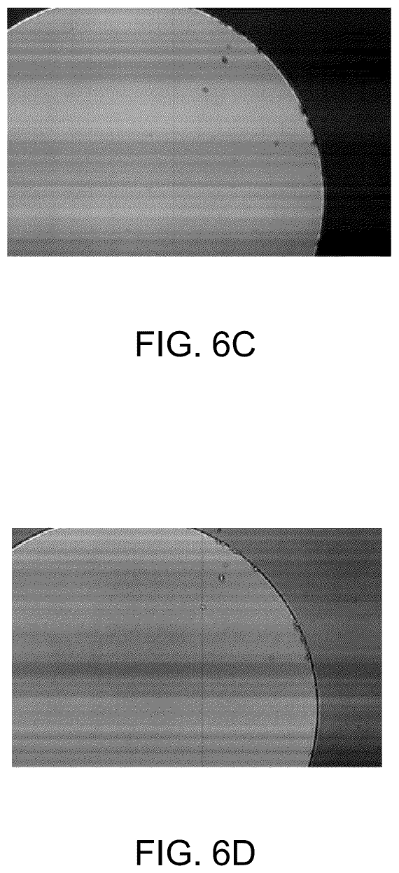

Four phase-shifting interferograms are obtained according to the camera frame number, as shown in FIG. 6A to FIG. 6D, and a four-step equal-step phase-shifting algorithm is adopted:

$$\begin{matrix}{I}_{1} ( x , y ) = {I}_{a} ( x , y ) + {I}_{m} ( x , y ) cos [ ϕ ( x , y ) - 3 α ( x , y ) ] \\ {I}_{2} ( x , y ) = {I}_{a} ( x , y ) + {I}_{m} ( x , y ) cos [ ϕ ( x , y ) - α ( x , y ) ] \\ {I}_{3} ( x , y ) = {I}_{a} ( x , y ) + {I}_{m} ( x , y ) cos [ ϕ ( x , y ) + 3 α ( x , y ) ] \\ {I}_{4} ( x , y ) = {I}_{a} ( x , y ) + {I}_{m} ( x , y ) cos [ ϕ ( x , y ) + 3 α ( x , y ) ]\end{matrix}$$

In the equations, Iᵢ(x,y) represents the i-th step phase-shifting interference intensity map (i=1, 2, 3, 4), Iₐ(x,y) is the background light intensity, Iₘ(x,y) Is the modulation intensity, α(x,y) is the phase-shifting amount, and (x,y) is the pixel coordinate information in the interferogram.

Phase information is calculated based on four interferograms:

$$ϕ ( x , y ) = {tan}^{- 1} \{ \frac{\sqrt{3 {( {I}_{2} - {I}_{3} )}^{2} - {( {I}_{1} - {I}_{4} )}^{2} + 2 ( {I}_{1} - {I}_{4} ) ( {I}_{2} - {I}_{3} )}}{- {I}_{1} + {I}_{2} + {I}_{3} - {I}_{4}} \}$$

If other phase-shifting algorithms are used, multiple phase-shifting interference intensity maps may be generated by adjusting the number of columns of pixels and the lateral spacing between pixels in multiple columns, and applied the multiple phase-shifting interference intensity maps to the corresponding phase-shifting algorithm.

The third aspect of the present disclosure provides an application of the above-mentioned phase measurement method to obtain the depth of the sample based on the phase to be measured, thereby obtaining the three-dimensional shape of the sample.

In a further preferred solution, the depth h(x,y) of the sample is obtained according to the following equation:

$$h ( x , y ) = \frac{λ}{2 π} \cdot ϕ ( x , y )$$

In the equation, λ is a wavelength of the sample.

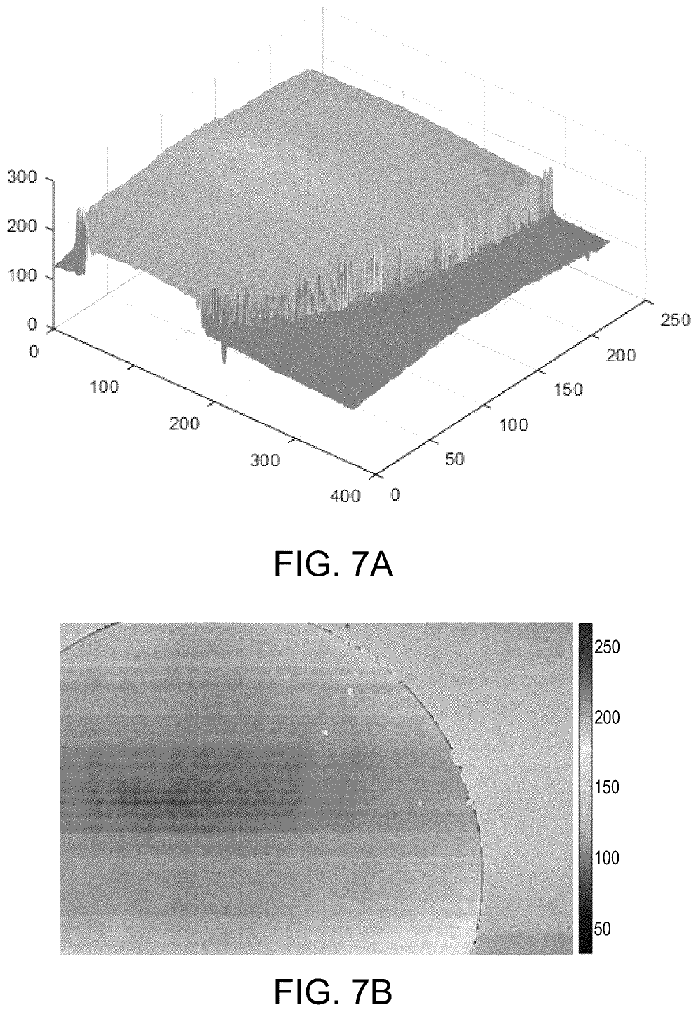

By repeating the above steps, the column phase images obtained each time are arranged, so that the complete phase change of the object is accurately obtained, thereby obtaining the three-dimensional topography of the sample, as shown in FIG. 7A and FIG. 7B. In this way, it is possible to achieve ultra-large field-of-view measurement that exceeds beyond the field of view of the objective lens itself while ensuring accuracy and speed.

It is easy for those skilled in the art to understand that the above descriptions are only preferred embodiments of the present disclosure and are not intended to limit the present disclosure. Any modifications, equivalent substitutions and improvements, etc., made within the spirit and principles of the present disclosure should all be included in the scope to be protected by the present disclosure.

What is claimed is:

1. A high-speed optical phase measurement system, comprising an illumination module, a microscope module, an interference module, a camera module, a high-precision positioning stage, and a control and data processing module, wherein
the illumination module comprises a collimated light source;
the microscope module comprises a beam splitter;
the interference module comprises an objective lens and a reference mirror, wherein a preset angle is set between the reference mirror and a plane perpendicular to an optical axis, and the preset angle is not 0°;
the high-precision positioning stage is configured to carry a sample, and a moving assembly is disposed under the high-precision positioning stage, thereby driving the sample to move;
a distance between the sample and the objective lens is equal to a distance between the objective lens and the reference mirror, and the reference mirror and the sample are both conjugate with a plane of the camera module;
an emitted light from the collimated light source enters the objective lens and the reference mirror after passing through the beam splitter, the emitted light is incident on a sample surface after passing through the objective lens, a reflected light reflected by the sample interferes with a reference light reflected by the reference mirror and is collected by the camera module;
the control and data processing module implements phase measurement based on interference images collected by the camera module.

2. The high-speed optical phase measurement system according to claim 1, wherein a relationship between a moving scanning speed of the high-precision positioning stage and the number of frames of the camera module is:
$$\frac{v}{fps} \times M = Pxsize$$
wherein v is the moving scanning speed of the high-precision positioning stage, fps is a frame rate of the camera, M is a system magnification, and Pxsize is a camera pixel size.

3. The high-speed optical phase measurement system according to claim 1, wherein the objective lens comprises a first objective lens and a second objective lens of the same model, the reference mirror is disposed at a focus of the first objective lens, the sample is disposed at a focus of the second objective lens, and the collimated light source is incident on the first objective lens and the second objective lens respectively after being split by the beam splitter.

4. The high-speed optical phase measurement system according claim 1, wherein the reference mirror is disposed between the beam splitter and a half-mirror in the objective lens, and a distance between the reference mirror and the half-mirror is the same as a distance between the half-mirror and the sample.

5. The high-speed optical phase measurement system according to claim 1, wherein the beam splitter is disposed between the objective lens and the sample, the reference mirror is disposed on a reflection optical path of the beam splitter, and a distance between the reference mirror and the beam splitter is equal to a distance between the sample and the beam splitter.

6. The high-speed optical phase measurement system according to claim 3, wherein an inclination angle of the beam splitter is 45°, and the preset angle α between the reference mirror and the plane perpendicular to the optical axis is obtained using the following equation:
$$α = arctan [ \frac{{f}_{2}}{{f}_{1}} tan {α}^{′} ]$$
$${α}^{′} = arctan ( \frac{\frac{2 π}{3} \times \frac{λ}{2 π}}{d} )$$
wherein f₁ is a focal length of the objective lens, f₂ is a focal length of a tube lens, λ is a central wavelength of a light source, and d is a distance between two columns of pixels.

7. A phase measurement method based on the high-speed optical phase measurement system according to claim 1, comprising:
S1: using a plurality of columns of pixels on the camera module as collection points, wherein the plurality of columns of pixels are distributed at equal intervals, and each of the plurality of columns of pixels is parallel to an interference fringe;
S2: activating the high-precision positioning stage for scanning, wherein when the interference fringe appears on a first column of pixels, an image signal is collected and stored in a first buffer area to form a first image sequence, when the interference fringe appears on a second column of pixels, the image signal is collected and stored in a second buffer area to form a second image sequence, in this way, the first image sequence, the second image sequence, . . . , and an N-th image sequence are obtained;
S3: processing an image at a starting point in the first image sequence, the second image sequence, . . . , and the N-th image sequence using a phase-shifting algorithm to obtain a phase of the sample to be measured.

8. The phase measurement method according to claim 7, wherein the phase-shifting algorithm in step S3 is specifically as follows:
$$ϕ ( x , y ) = {tan}^{- 1} \frac{{\sum }_{n = 0}^{N - 1} {I}_{n} ( x , y ) sin ( 2 π n / N )}{{\sum }_{n = 0}^{N - 1} {I}_{n} ( x , y ) cos ( 2 π n / N )}$$
wherein ϕ(x,y) is the phase to be measured, and Iₙ(x,y) is the image at the starting point in the N-th image sequence.

9. An application of the phase measurement method according to claim 7, wherein a depth of the sample based on the phase to be measured is obtained, and thereby obtaining a three-dimensional morphology of the sample.

10. The application according to claim 9, wherein the depth h(x,y) of the sample is obtained according to the following equation:
$$h ( x , y ) = \frac{λ}{2 π} \cdot ϕ ( x , y )$$
wherein λ is a wavelength of the sample.
